(19) United States
(12) Patent Application Publication
(10) Pub. No.: US 2013/0235375 A1
(43) Pub. Date: Sep. 12, 2013

(54) SENSOR SUBSTRATE FOR SURFACE-ENHANCED SPECTROSCOPY

(71) Applicant: Fraunhofer-Gesellschaft Zur Foerderung Der Angewandten Forschung E.V., (US)

(72) Inventors: Julia KATZMANN, Dresden (DE); Thomas Haertling, Dresden (DE)

(73) Assignee: Fraunhofer-Gesellschaft Zur Foerderung Der Angewandten Forschung E.V., Muenchen (DE)

(21) Appl. No.: 13/788,090

(22) Filed: Mar. 7, 2013

(30) Foreign Application Priority Data
Mar. 9, 2012 (DE) 102012004582.4

(51) Int. Cl. G01J 3/02; G02B 5/20

(52) U.S. Cl. CPC G01J 3/0205; G02B 5/20
USPC 356/301; 250/339.01; 359/350

(57) ABSTRACT

The present invention relates to a sensor substrate for surface-enhanced spectroscopy, which is transparent in the infrared and/or visible spectral range and is penetrated by a plurality of continuous channels. In the channels, a plurality of metallic nanotubes spaced from one another in the longitudinal direction of the channels are formed as antenna elements by portions of metallic coating. The proposed sensor substrate can be produced with a large area in a simple manner and enables selective adjustment of the plasmon resonance via the length of the antenna elements.

### TECHNICAL FIELD

The present invention relates to a sensor substrate for surface-enhanced spectroscopy, which is transparent for infrared and/or visible radiation and is penetrated by a plurality of continuous channels, in which a plurality of antenna elements spaced from one another in the longitudinal direction of the channels are formed by portions of metallic coating. The invention also relates to the use of the proposed sensor substrate in surface-enhanced infrared (IR) spectroscopy and surface-enhanced raman spectroscopy.

Infrared spectroscopy is a versatile optical analysis technique, which plays an important role in many scientific fields. For example, it is used in the chemical and pharmaceutical industry, bioengineering, medicine and safety engineering. It is used for label-free characterisation and identification of molecular species in solid bodies, liquids and gases. The fact that the molecule has the property of having specific absorption bands, which can be detected by means of IR spectroscopy, in the middle IR range of the electromagnetic spectrum, that is to say in a wavelength range from approximately 3 to 10 μm, is used for identification. The IR absorption of molecules has very small cross sections however. This limits the detection of small substance quantities and hinders the sensor technology based on IR spectroscopy.

The sensitivity of IR spectroscopy of molecules can be increased by the technique of what is known as surface-enhanced infrared spectroscopy (SEIRS). Here, specially formed substrates are used, which locally enhance the incident infrared radiation. The local regions of enhanced infrared radiation are also referred to as hotspots. The analytes to be examined are applied in this case to the substrate illuminated with infrared radiation. If molecules are located in the vicinity of a hotspot, they can absorb a particularly high proportion of the infrared radiation and the detection signal can thus be enhanced. For enhancement of the excitation light, the oscillations of free electrons in metals, that is to say of surface plasmons is utilised. An enhancement effect of this type thus occurs for example with a gold wire a few micrometres in length, around the wire ends of which a high electromagnetic field forms due to the optically excited electron oscillation. Molecules in the region of these wire ends experience the enhanced electromagnetic field and thus deliver an increased detection signal.

### PRIOR ART

A sensor substrate for surface-enhanced IR spectroscopy is known from EP 2 199 777 A1, in which a nanoscale metallic layer is applied to a dielectric substrate such that narrowly spaced metallic islands are formed. The enhancement effect occurs at the edges of these islands.

Neubrech et al., “Resonant Plasmonic and Vibrational Coupling in a Tailored Nanoantenna for Infrared Detection”, Phys. Rev., Lett. 101, 157403-1 to 157403-4 (2008), show the field-enhancing effect of nanowires which have been deposited on a planar substrate. The length of the nanowires is selected such that it corresponds approximately to half the wavelength of the IR radiation to be enhanced. This technique is too costly however for the production of large-area sensor substrates, as are necessary for industrial use.

A sensor substrate for surface-enhanced IR spectroscopy that is penetrated by continuous channels is known from US 2008/0297802 A1. A plurality of annular antenna elements spaced from one another in the longitudinal direction of the channels are formed in the channels by portions of metallic coating in order to enhance the infrared radiation.

The previously known sensor substrates either do not allow targeted adjustment of the plasma resonance or cannot be produced with a large area in a simple manner.

The object of the present invention is to specify a sensor substrate for surface-enhanced spectroscopy, which can be produced with a large area in a simple manner, allows an adjustment of the plasma resonance during production and has high sensitivity for the detection of molecules.

### DISCLOSURE OF THE INVENTION

The object is achieved with the sensor substrate according to Claim 1. Advantageous embodiments of the sensor substrate are subject of the dependent claims or can be inferred from the following description and the exemplary embodiment.

The dielectric sensor substrate, which is transparent in the infrared and/or visible spectral range, is penetrated by continuous channels. The continuous channels are to be understood to mean channels that are open to opposed surfaces of the substrate and therefore allow the analyte to be measured to flow through. The optical transparency in the infrared spectral range is based in particular on the range between 1 μm and 10 μm and is necessary with use of the substrate in IR spectroscopy. With use in raman spectroscopy, the substrate should be transparent in the visible spectral range, that is to say in particular in the range between 380 nm and 780 nm. With the proposed sensor substrate, sections of the inner faces of the channels are coated with metal such that a plurality of metallic nanotubes following one another in the longitudinal direction of the channels and spaced from one another are formed as antenna elements having a length of ≧500 nm, preferably between 1 μm and 10 μm.

In another embodiment, as is suitable for raman spectroscopy, the nanotubes have a length between approximately 50 nm and approximately 400 nm. The term “nanotubes” is to be understood in this instance to mean tubular metallic structures having a ratio of length to outer diameter of ≧3, preferably ≧5, wherein the outer diameter is in the nanometre range, that is to say less than 1 ∥m, preferably ≦500 nm. The mutual spacing of the channels (edge-to-edge spacing) can be less than 100 nm so that a very high packing density is achieved. The channels in the substrate must therefore have corresponding dimensions. The length of the nanotubes is selected in each case such that it corresponds to approximately half the wavelength of the infrared radiation to be enhanced or of the radiation in the visible spectral range for the respective application.

With the proposed sensor substrate, the plasma resonance can be selectively adjusted over the length of the antenna elements, for example in the middle infrared range and therefore in the spectral range of molecule oscillations. By matching the plasma resonance and molecule oscillation frequency, a very high enhancement factor of the SEIRS signal can be achieved. Due to the formation of the antennas in the channels or pores of a substrate, 3D integration and a very high packing density of the plasmonically active antenna elements is achieved. This also leads to an improved sensitivity with use of this substrate in IR spectroscopy. The proposed sensor substrate can be produced with a large area in a simple manner, as will be described in greater detail further below.

The locations of greatest enhancement occur with the proposed sensor substrate at the ends of the antenna elements or nanotubes. In an advantageous embodiment these nanotubes in the longitudinal direction of the channels only have a mutual spacing from one another of ≦10 nm. The electrically non-conductive gap between the nanotubes forms the hotspots, in which the electric field is further increased with respect to the end of an individual nanoantenna. If the antenna is excited with its resonance wavelength and analyte molecules are located in the region of the gap, there is enhanced excitation of the infrared-active oscillation bands of the molecules in the resonant spectral range of the antenna. This can be detected in a known manner with a transmission measurement as an absorption line in the recorded infrared spectrum.

Due to the hollow formation of the antenna in the form of nanotubes, the analytes, in particular liquids and gases, are transported directly to the hotspots. The diameter of the nanotubes may range from less than 10 nm to more than 100 nm and is preferably ≦150 nm.

The formation in form of nanotubes provides the further advantage that only a very small amount of analytes has to be used for the measurement. Furthermore, it is possible to also carry out measurements with aqueous analytes. Water absorbs infrared radiation very strongly and therefore, with many other sensor substrates, prevents the analysis of processes that take place in an aqueous environment. This constitutes a significant problem, since infrared spectroscopy is then rejected in many fields of medicine and biochemistry for which it is actually best suited. With the proposed sensor substrate however, a measurement with aqueous analytes can also be carried out since the absorption by the water is only low in this case due to the small amount of analyte in the channels.

The above embodiments and advantages are also valid analogously for the use of the sensor substrate in raman spectroscopy, wherein merely the length of the nanotubes or antenna elements then has to be selected so as to be shorter accordingly.

For example, an anodised metal oxide or (porous) silicon with correspondingly formed pores, which form the continuous channels, can be used as substrate material. The pores or channels in the substrate are preferably aligned at least approximately parallel to one another and extend between the two main faces of the substrate. In a particularly advantageous embodiment anodised aluminium oxide is used as a substrate material. The diameter and spacings of the parallel pore channels formed when the aluminium is anodised can be adjusted in a known manner by the parameters of the anodising process, in particular by the voltage applied during anodisation. The substrate preferably consists of an electrically non-conductive material.

When producing the proposed sensor substrate, for example from the aforementioned anodised aluminium oxide, multisegmented metallic tubes are deposited in the channels, as is described for example from W. Lee et al., “A Template-Based Electrochemical Method for the Synthesis of Multisegmented Metallic Nanotubes”, Angew. Chem. Int. Ed. 2005, 44, 6050-6054, to produce metallic nanotubes. This publication is incorporated into the present description by reference with regard to the description of the production of multisegmented metallic nanotubes in a substrate penetrated by continuous channels. The metallic nanotubes are deposited in the channels by means of electrodeposition in the case of this production method. Whilst the deposited nanotubes are then removed from the substrate by an etching process in the cited publication, they remain in the channels in the substrate in the case of the production of the sensor substrate according to the invention. The individual metallic segments are deposited along the longitudinal direction of the channels, for example in a sequence A-B-A, by electrodeposition, wherein A and B represent different metals. The segments of the metal B are used here to generate the gap between the subsequent antenna elements made of the metal A. The segments of the metal B are therefore preferably generated with a length of ≦10 nm, as measured along the longitudinal direction of the channels, whereas the length of the segments of the metal A is preferably between 1 and 10 μm. After this generation of the multisegmented metallic tubes in the channels, the metal B is removed selectively using a suitable etching medium in order to obtain the electrically non-conductive gaps between the nanotubes thus obtained made of the metal A. The corresponding gap is then located at the locations at which the metal B was previously deposited. The etching medium for selectively etching the metal B can be fed through the channels in a simple manner. In this case, Au and Ag are suitable metals for the metal A, whereas Ag and Ni are suitable metals for the metal B. For example, HCl can be used as a suitable etching solution for the selective etching of Ni, and HNO₃ for example can be used for Ag. A sensor substrate of this type can be produced over a large area with a high density of channels. Only processes that are easily handled, such as the known anodisation and electrodeposition, are necessary for the production of the substrate with the channels and nanotubes deposited therein.

The proposed sensor substrate can be used for example in surface-enhanced IR spectroscopy and also in surface-enhanced raman spectroscopy (SERS) and enables high detection sensitivity for the molecules to be detected. Here, the analytes to be measured are transported through the channels of the substrate, which is irradiated at the same time with IR light or visible light. The IR light transmitted through the substrate or the analytes into the nanotubes is detected with spectral resolution in order to detect the corresponding absorption lines or absorption bands of the molecules located therein in the IR range. In the case of raman spectroscopy the light scattered in the analyte is detected with spectral resolution. The sensor substrate therefore enables label-free characterisation and identification of molecular species in analytes, in particular in liquids and gases, and can be used for example in the chemical and pharmaceutical industry, bioengineering, medicine and safety engineering.

### BRIEF DESCRIPTION OF THE DRAWINGS

The proposed sensor substrate will be explained again briefly hereinafter on the basis of an exemplary embodiment in conjunction with the drawings, in which:

FIG. 1 shows a schematic illustration of a plan view of an example of the proposed sensor substrate; and

FIG. 2 shows a sectional illustration of an example of the proposed sensor substrate.

### EMBODIMENTS OF THE INVENTION

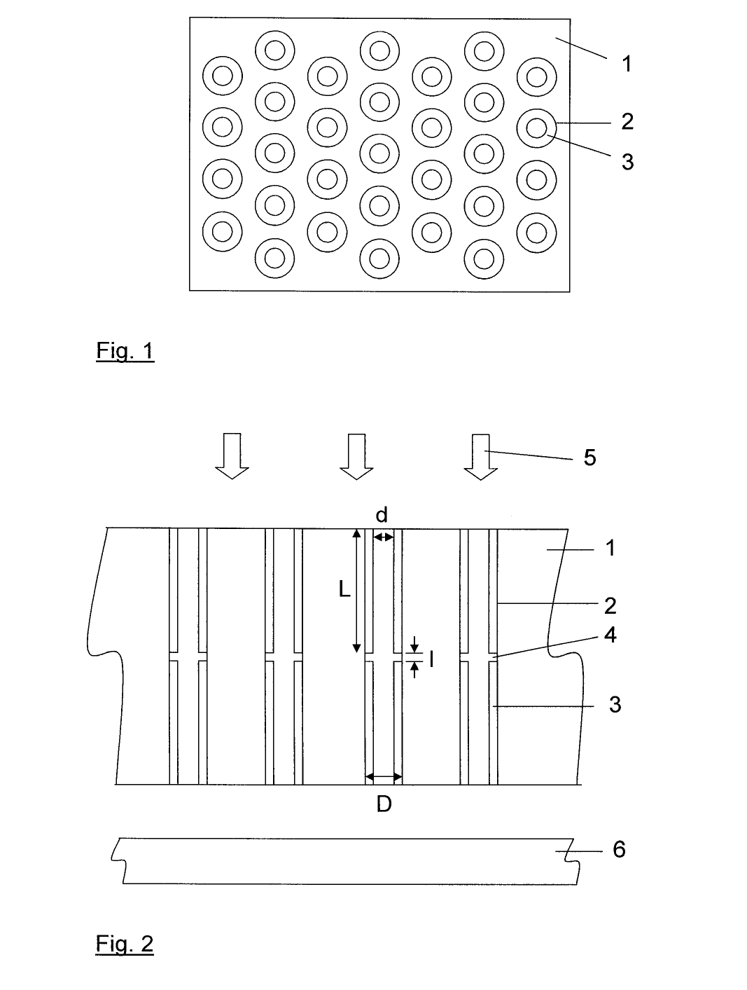

The sensor substrate illustrated hereinafter by way of example is formed of anodised aluminium oxide of which the pore channels have been adjusted selectively during the anodising process to the dimensions specified in this example. Here, FIG. 1 shows a plan view of a detail of the substrate 1, in which the openings of the pore channels 2, which penetrate the substrate 1, can be seen in a schematic manner. Sections of the inner faces of the pore channels 2 running in parallel are coated with gold to form metallic nanotubes 3. Due to the production method of a substrate 1 of this type, a high pore density with mutual spacings between the edges of the pore channels 2 of less than 100 nm can be achieved.

FIG. 2 shows a schematic view of a section through a substrate 1 of this type, in which the continuous pore channels 2 can be seen, which extend between the two main faces of the substrate 1. In FIG. 2, the coating of sections of the inner faces of the pore channels 2 can be seen, as a result of which the individual metallic nanotubes 3 are formed. These nanotubes 3 constitute the field-enhancing antennas of the proposed sensor substrate. The length L of these antennas is set such that the plasma resonance lies in the middle infrared range and therefore in the spectral range of molecule oscillations. Due to this matching of plasma resonance and molecule oscillation frequency, a very high enhancement factor of the SEIRS signal can be achieved. The number of nanotubes 3 formed in the longitudinal direction of the pore channels 2 is not limited here to the two nanotubes illustrated in this case. Rather, a larger number of nanotubes may also be arranged in the pore channels 2.

Electrically non-conductive gaps 4 are formed between the individual nanotubes 3 in the longitudinal direction of the pore channels 2. In these gaps 4, the electric field is further increased compared to the end of an individual nanotube. The gaps 4 preferably have a length 1 of <10 nm.

With IR spectroscopy, the substrate 1 is irradiated with infrared light 5 from one side (collimated or focused vertically or at an angle) and the radiation passing through the substrate 1 is detected by a detector 6 with spectral resolution. The analyte to be measured is transported through the cavities in the individual nanotubes 3 or is introduced thereinto. If analyte molecules are located in the region of the superelevated electric field in the gap 4 between the individual nanotubes 3 or nanoantennas, there is an enhanced excitation of the infrared-active oscillation bands of the molecule in the resonant spectral range of the antenna. Due to the transmission measurement with the detector 6, these oscillation bands can be detected as absorption lines in the recorded IR spectrum. The respective molecule can thus be identified via the measured absorption lines or absorption bands.

The inner diameter d of the cavity of the nanotubes 3 is preferably <150 nm and may range up to less than 10 nm. Liquids or gases can be used as analytes. Due to the small amount of analyte used in this case, aqueous solutions can also be used. The outer diameter D of the nanotubes 3, which corresponds to the inner diameter of the pore channels 2 of the substrate 1, is preferably <500 nm. The total thickness of the substrate (in the longitudinal direction of the pore channels) may be between 1 μm and 100 μm for example with lateral dimensions of the substrate between 1 mm and several cm.

While the invention has been illustrated and described in detail in the drawings and forgoing description, such illustration and description are to be considered illustrative or exemplary and not restrictive; the invention is not limited to the disclosed embodiments. Other variations of the disclosed embodiments can be understood and effected by those skilled in the art in practicing the claimed invention, from a study of the drawings, the disclosure, and the appended claims. In the claims the word “comprising” does not exclude other elements or steps and the indefinite article “a” or “an” does not exclude a plurality. The mere fact that certain measures are recited in mutually different dependent claims does not indicate that a combination of these measures can not be used to advantage. In particular, all claims can be freely combined as far as the combined claims are not contradictory.

### LIST OF REFERENCE SIGNS

1 substrate
2 pore channels
3 nanotubes or nanoantennas
4 gap
5 IR radiation
6 detector

1. A sensor substrate for surface-enhanced spectroscopy,
said sensor substrate being transparent in at least one of the infrared and visible spectral range, and being penetrated by a plurality of continuous channels,
a plurality of antenna elements being formed by sections of metallic coating in said channels, said antenna elements being spaced from one another in the longitudinal direction of the channels,
wherein
the antenna elements are nanotubes having a length in said longitudinal direction and having an outer diameter, a ratio of said length to said outer diameter being ≧3.

2. The sensor substrate according to claim 1,
wherein the nanotubes have a mutual spacing of ≦10 nm in the longitudinal direction of the channels.

3. The sensor substrate according to claim 1,
wherein the nanotubes have an inner diameter of <150 nm.

4. The sensor substrate according to claim 1,
wherein the channels extend parallel to one another in the substrate.

5. The sensor substrate according to claim 1,
wherein the substrate is formed from an anodised metal oxide.

6. The sensor substrate according to claim 1,
wherein the substrate is formed from porous silicon.

7. The sensor substrate according to claim 1,
wherein the sensor substrate is transparent in the infrared spectral range and the nanotubes have a length of ≧500 nm.

8. The sensor substrate according to claim 1,
wherein the sensor substrate is transparent in the visible spectral range and the nanotubes have a length in the range from 50 to 400 nm.

9. Use of the sensor substrate according to claim 7 in surface-enhanced infrared spectroscopy, wherein an analyte to be examined is introduced into the channels in the substrate, the substrate is irradiated with infrared light and the infrared light transmitted through the substrate and the analyte is measured by a detector with spectral resolution.

10. Use of the sensor substrate according to claim 8 in surface-enhanced raman spectroscopy, wherein an analyte to be examined is introduced into the channels in the substrate, the substrate is irradiated with light in the visible spectral range and the light scattered through the analyte is measured by a detector with spectral resolution.

11. The sensor substrate according to claim 2,
wherein the nanotubes have an inner diameter of <150 nm.

12. The sensor substrate according to claim 2,
wherein the channels extend parallel to one another in the substrate.

13. The sensor substrate according to claim 2,
wherein the substrate is formed from an anodised metal oxide.

14. The sensor substrate according to claim 2,
wherein the substrate is formed from porous silicon.

15. The sensor substrate according to claim 2,
wherein the sensor substrate is transparent in the infrared spectral range and the nanotubes have a length of ≧500 nm.

16. The sensor substrate according to claim 2,
wherein the sensor substrate is transparent in the visible spectral range and the nanotubes have a length in the range from 50 to 400 nm.

17. Use of the sensor substrate according to claim 15 in surface-enhanced infrared spectroscopy, wherein an analyte to be examined is introduced into the channels in the substrate, the substrate is irradiated with infrared light and the infrared light transmitted through the substrate and the analyte is measured by a detector with spectral resolution.

18. Use of the sensor substrate according to claim 16 in surface-enhanced raman spectroscopy, wherein an analyte to be examined is introduced into the channels in the substrate, the substrate is irradiated with light in the visible spectral range and the light scattered through the analyte is measured by a detector with spectral resolution.
